(19) United States
(12) Patent Application Publication
(10) Pub. No.: US 2024/0017969 A1
(43) Pub. Date: Jan. 18, 2024

(54) AUTOMATIC METHOD FOR DETERMINING A PHYSICAL END-OF-TRAVEL POSITION OF A REEVE-BLOCK OF A TOWER CRANE

(71) Applicant: MANITOWOC CRANE GROUP FRANCE, DARDILLY (FR)

(72) Inventors: Matthieu CORMIER, CHAMPAGNE AU MONT D’OR (FR); Jonathan CHALAVON, MIONS (FR); Cédric FOURIER, CROTTET (FR)

(21) Appl. No.: 18/351,159

(22) Filed: Jul. 12, 2023

(30) Foreign Application Priority Data
Jul. 12, 2022 (FR) 2207168

(51) Int. Cl. B66C 13/50; B66D 3/24; B66D 3/04

(52) U.S. Cl. CPC B66C 13/50; B66D 3/24; B66D 3/043

(57) ABSTRACT

An automatic method for determining a physical end-of-travel position (zphys) of a reeve-block of a crane which may be moved in ascent and in descent by means of a lifting cable comprises a phase of ascent of the reeve-block during which a force on a strand of the lifting cable is monitored by a monitoring device, which may be a load sensor such as a gauge pin. The physical end-of-travel position is reached and determined depending a variation of the force on the strand of the lifting cable. From this physical end-of-travel position, a maximum end-of-travel position (zmax) may be determined in particular, which is a position not to be exceeded by the reeve-block when the crane is working.

### FIELD

The present disclosure generally relates to the technical field of cranes, and in particular tower cranes. For example, the present subject matter relates to an automatic method for determining of a physical end-of-travel position of the reeve-block of the crane.

The subject matter of the present disclosure finds a non-limiting application for top-slewing cranes and self-erecting cranes.

### BACKGROUND

As is known, when a crane is working and a load is lifted by its reeve-block during an upward lifting, the reeve-block may move in ascent until it reaches a height limit corresponding to an upper end-of-travel position, and distant from the underside of a distribution trolley, on which the reeve-block is suspended, by a predefined safety distance. The purpose of stopping the reeve-block at this upper end-of-travel position is to prevent it, during its ascent, from hitting the distribution trolley mobile in translation on the jib. A collision between the trolley and the reeve-block may on the one hand damage them both, as well as eventually the elements of the jib; and on the other hand potentially cause an overtension and a breakage of the lifting cable, as well as the fall of all or part of the load lifted by the reeve-block on the ground, risking damage to material and/or injury to a worker located under the reeve-block when the load is falling.

The upper end-of-travel position is a parameter that the control-command system of the crane stores following a determination procedure provided for determining it, and which is normally performed by the crane operator at the start of the day during the commissioning of the crane; and that the control-command system then automatically applies the rest of the day when the crane is working and maneuvered during one or several lifting operations, with lifting limiters in communication with the control-command system decreasing the speed of the reeve-block when it approaches the upper end-of-travel position, and stopping it when it reaches it.

Conventionally, the determination procedure is carried out manually, with the crane operator visually estimating the safety distance and bringing back the reeve-block, which is not carrying a load, to the upper end-of-travel position he deems correct. Consequently, this determination procedure is imprecise, with an upper end-of-travel position estimated more or less close to the real upper end-of-travel position, and therefore not easily reproducible from one determination procedure to another. This is why additional safety margins in terms of distance are taken by the crane operator vis-à-vis the upper end-of-travel position, so that the crane is not used optimally. It is also not uncommon for the crane operator to omit to carry out this operation at start-up to start the work of the crane as soon as possible.

Known solutions, such as those of documents WO21243981 and CN208964423, propose automatically stopping the reeve-block at the upper end-of-travel position by means of electronic devices which have the disadvantage of: being added to the equipment already included in the crane and communicating with its control-command system; and which consist of several elements. The solution proposed for example in WO21243981 comprises in particular for its implementation a link table, a programmable controller, a frequency converter, and a Modbus^{R} communication multi-loop absolute value encoder communicating with the lifting motor of the crane; all of these elements being in interaction and the programmable controller communicating with the control-command system.

The document US2020/0247647A1 proposes, for the telescopic jib cranes, to determine an intermediate position of a hook corresponding to a position of change of state of the lifting cable and of the sling cables, which pass from a released state to a tensioned state, in order to avoid a horizontal swing phenomenon when lifting the load.

### SUMMARY

The present disclosure proposes to respond to the drawbacks mentioned above, by means of an automatic method for determining a physical end-of-travel position for the load lifting operations. The advantages of this automatic method are the following:
a reduction in human intervention, which therefore may minimize the risk of human error and may provide a gain in safety;
the reproducibility of the automatic method and the repeatability of the adjustments which may result from the determination of the physical end-of-travel position.

Another object of the present disclosure is to determine with precision, following the determination of the physical end-of-travel position, the upper end-of-travel position when the crane is working, the upper end-of-travel position being latter called maximum end-of-travel position.

Embodiments of the present disclosure may provide two advantages on this particular point:
saving of time during the commissioning of the crane, the automatic method determining the physical end-of-travel position quickly while the crane operator generally estimates the maximum end-of-travel position for at least ten minutes, offering thus a considerable saving of time for the exploitation and the profitability of the crane;
an improvement in performance, particularly in terms of height under hook. Since the physical end-of-travel position and the maximum end-of-travel position are estimated with precision, it is possible to eventually reduce the distance (sometimes referred to as a “safety distance”) separating the two positions, thus optimizing the capacities of the crane.

Another object of the present disclosure is that the automatic method be implemented without adding equipment to those already included in the crane.

Another object of the present disclosure, in connection with the previous one, is that the automatic method of determination be implemented by the control-command system of the crane.

Thus, the present disclosure proposes an automatic method for determining a physical end-of-travel position of a reeve-block of a crane which may be moved in ascent and in descent by means of a lifting cable, said reeve-block being suspended by the lifting cable from a distribution trolley, said automatic method comprising a phase of ascent of the reeve-block during which a force on a strand of the lifting cable is measured by a monitoring device, said physical end-of-travel position, which corresponds to a position wherein the reeve-block is physically in contact with the distribution trolley, being reached and determined depending on a variation of the force on the strand of the lifting cable.

In other words, the determination of the physical end-of-travel position is implemented in an automated manner and is based on a measurement by a device for monitoring the force exerted on the lifting cable lifting the reeve-block when said reeve-block is raised in the direction of the jib of the crane during an ascent phase; the physical end-of-travel position being reached and determined when a variation of the force is measured by this monitoring device during this phase of ascent of the reeve-block.

Indeed, as long as the reeve-block is below the physical end-of-travel position, the force on the strand of the lifting cable is stable, and on the other hand, once the physical end-of-travel position is reached (in other words during a physical contact with the reeve-block), this force varies suddenly, and it is this variation which indicates that the physical end-of-travel position has been reached.

In the automatic method, the variation of the force on the strand of the lifting cable is observed from the moment the reeve-block comes into contact with the underside of the trolley mounted on the jib of the crane.

According to one characteristic, the physical end-of-travel position is determined from an increase of the force on the strand of the lifting cable.

In other words, the variation of the force on the cable strand observed at the moment of contact between the reeve-block and the trolley results in an increase of this force, and in particular a sudden increase.

According to one characteristic, the increase of the force on the strand of the lifting cable is characterized by an exceeding of the force beyond a given force threshold, or by a slope of variation of the force above a given slope value.

In other words, during the ascent phase, the force on the strand is representative of the weight lifted by the lifting cable. The physical end-of-travel position is determined and considered to have been reached if:
the force on the strand exceeds a force threshold representative of an additional tension exerted on the cable and which would not be solely due to the weight lifted by the lifting cable. More precisely, the force threshold is representative of the weight lifted by the cable to which is added the overtension occurring, for this given weight, when the reeve-block comes into contact with the trolley; and/or
the increase of the force is sufficiently abrupt/rapid in time, that is to say it presents a strong slope of variation over a very short time interval, meaning that the instant t preceding this slope corresponds to the moment of contact of the reeve-block with the trolley, and that the slope corresponds to the lifted weight added to the overtension exerted in the lifting cable by the lifted weight and the force which the reeve-block exerts by being blocked under the trolley while trying to continue to ascend.

According to one characteristic, the ascent phase is carried out with the reeve-block empty.

Thus, the force on the strand during the ascent phase and before the reeve-block comes into contact with the trolley is only due to the weight of the reeve-block itself.

The ascent phase is carried out with the reeve-block empty for several reasons:
do not exert unnecessary overtension on the lifting cable at the moment of contact between the reeve-block and the trolley by attaching a load to the hook of the reeve-block;
the weight of the reeve-block being constant, the forces on the strand observed before and at the moment of contact are both invariant from one implementation of the automatic method to another, thus making the automatic method precise and reproducible.

According to one characteristic, the ascent phase is carried out at an ascent speed below a minimum speed.

The reeve-block is raised at low speed during the ascent phase and the determination of the physical end-of-travel position in order to prevent the reeve-block from colliding too quickly with the trolley to which it is suspended and thus, may avoid the reeve-block damaging the trolley in the event of a collusion (and/or also the reeve-block getting damaged by the trolley). This speed does not exceed a predetermined minimum speed depending on the type of the crane, as well as the drive, the winch, and the reeving system used.

According to one characteristic, the ascent phase is stopped as soon as the physical end-of-travel position is reached and determined.

In other words, when the variation of the force on the strand of the lifting cable is observed by the monitoring device, this means that the reeve-block has just reached the physical end-of-travel position. Its upward progression, and therefore the ascent phase, is immediately stopped. The physical end-of-travel position is then stored by the crane (for example, by a memory of a control-command system).

According to one characteristic, the monitoring device is a load sensor mounted on the crane to be able to measure a self-weight of the reeve-block.

In other words, this characteristic proposes to use a load sensor which is conventionally present on the crane, because it is used to determine the weight of the load suspended from the reeve-block, which is advantageous because it does not use a dedicated sensor, but rather a sensor already present.

According to one embodiment, the load sensor is a gauge pin mounted on a system for returning the lifting cable.

In other words, the gauge pin is mounted on a return system on which the lifting cable is wound or unwound, the gauge pin measuring a torsional force from which the force exerted on the strand of the cable is deductible.

Advantageously, the gauge pin is an integral part of the equipment installed on the crane in order to measure the force exerted on the lifting cable and to ensure the smooth running of the lifting operations when the crane is working. That is, the gauge pin is not an additional monitoring device added to the crane for the sole purpose of allowing the determination of the physical end-of-travel position.

According to one characteristic, the automatic method comprises a step of calculating a maximum end-of-travel position of the reeve-block, located below the physical end-of-travel position at a predefined safety distance.

More precisely, the physical end-of-travel position, once determined, is used as a reference in order to calculate the maximum end-of-travel position of the reeve-block. The calculation involves the safety distance separating the two positions, which is different depending on the type of crane considered. According to the present disclosure, this safety distance may be reduced compared to what is currently implemented when the maximum end-of-travel position is established manually and visually.

According to one characteristic, the safety distance is comprised between 40 and 100 cm.

Advantageously, the safety distance is defined so that the automatic method may be implemented in the top-slewing cranes (for a safety distance adapted between 80 and 100 cm) and the self-erecting cranes (for a safety distance adapted between 40 and 80 cm).

According to one characteristic, once the physical end-of-travel position has been reached and determined, the reeve-block descended until it reaches the maximum end-of-travel position.

In other words, once the reeve-block has reached the physical end-of-travel position, it descended by a height corresponding to the safety distance to reach the maximum end-of-travel position, which is then stored by the crane (more precisely by the memory of the control-command system of the crane).

According to one characteristic, the maximum end-of-travel position is a maximum position not to be exceeded for the reeve-block when the crane is working.

As previously indicated, the maximum end-of-travel position corresponds to the upper end-of-travel position corresponding to the height at which the reeve-block is stopped when carrying a load and moving upwards in the direction of the jib when the crane is working.

According to one characteristic, the automatic method is carried out when starting the crane, before any work of moving a load.

According to the present disclosure, this method may be implemented in a forced manner each time the crane is started, without the possibility for the crane operator to derogate from it.

According to one characteristic, the automatic method may be repeated between two periods of activity of the crane.

Advantageously, the crane operator has the possibility of restarting the automatic method during the day so that the physical and maximum end-of-travel positions are again determined and adjusted, for example if he observes, following any action of the crane (a lifting or distribution maneuver for example), a remarkable modification or an inconsistency in the height at which the reeve-block stops when it has to return to its maximum end-of-travel position.

So that the physical and maximum end-of-travel positions may be determined again with precision, the automatic method must be restarted between two periods of activity of the crane, after taking care that no load is suspended on the reeve-block.

According to one characteristic, the automatic method is implemented in a control/command system included in the crane, said control/command system being linked at least to a lifting winch coupled to the lifting cable, and to the monitoring device.

Advantageously, the automatic method is implemented in the control-command system of the crane and implemented by the latter.

In the event that a load sensor (such as a gauge pin) is used as a monitoring device, this means that no external additional equipment, either for the implementation or the execution of the automatic method, or for the monitoring and the measurement of the force exerted on the strand, is necessary in the determination of the physical end-of-travel position.

### BRIEF DESCRIPTION OF THE DRAWINGS

Other characteristics and advantages of the present invention will become apparent on reading the detailed description below, of a non-limiting example of implementation, made with reference to the appended figures in which:

FIG. 1 is a schematic view of a crane illustrating the control/command system linked in particular to the lifting winch which is coupled to the lifting cable used to lift and lower the reeve-block, as well as to the monitoring device used to measure/monitor the force of one of the strands of the lifting cable, in an application context for which the ascent phase of the automatic method is implemented by the control command system, with the reeve-block being raised in the direction the jib of the crane;

FIG. 2 is a schematic view equivalent to FIG. 1, for which the ascent phase of the automatic method is stopped, with the reeve-block which has come into contact with the underside of the distribution trolley and which has reached the physical end-of-travel position;

FIG. 3 is a curve showing the evolution of the force measured by the monitoring device on the strand of the considered lifting cable, during the ascent phase and after the reeve-block has come into contact with the underside of the distribution trolley;

FIG. 4 is a schematic view equivalent to FIGS. 1 and 2, for which the control/command system implements a descent phase during which the reeve-block descended from the physical end-of-travel position to the maximum end-of-travel position; and

FIG. 5 is a curve showing the evolution of the speed at which the reeve-block is raised in the direction of the jib when the crane is working, the speed gradually undergoes decelerations when it reaches different positions determined once the physical end-of-travel position known.

### DESCRIPTION

The automatic method for determining a physical end-of-travel position zphys according to the present disclosure is implemented and executed by the control/command system 6 of the crane 1, which control/command system 6 may be installed for example in the control cabin of the crane 1.

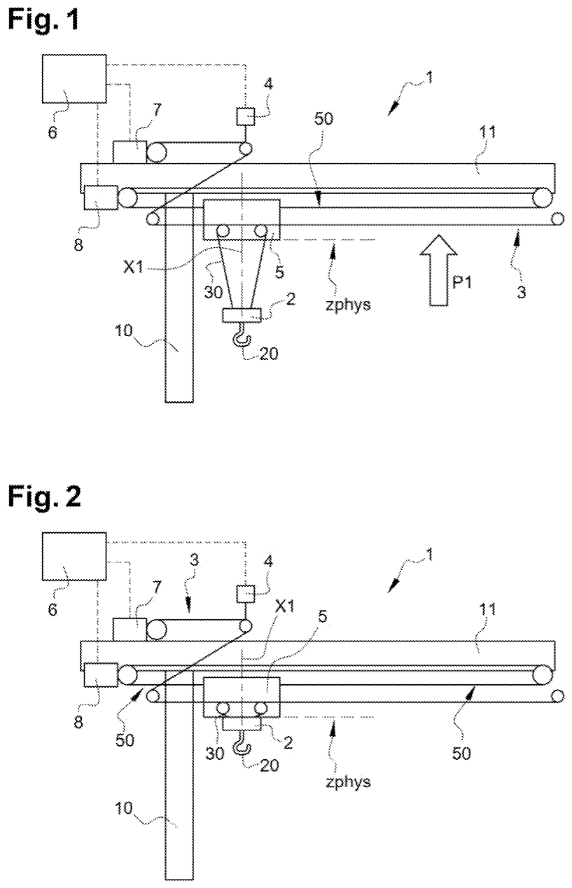

Referring to the simplified diagram of FIG. 1, the crane 1 is a tower crane which comprises a mast 10 mounted on a platform which may be fastened to the ground or may be mobile (for example by being placed on rails); and a rotating assembly formed at least by a jib 11 and a counter-jib, not shown, substantially aligned, said rotating assembly being rotated about a slewing axis of vertical extension, by means of a slewing rim coupled to at least one slewing motor, causing the jib F to scan a circular area around the slewing axis.

The loads are lifted by the crane 1 by means of a hook located at the end of a reeve-block 2 which is moved vertically by means of several strands of a lifting cable 3. The reeve-block 2 is raised in the direction of the jib 10 and descended in the direction of the ground by winding and unwinding the lifting cable 3 around the cylinder of a lifting winch 7 coupled to a lifting motor, with several pulleys serving to transmit the movement of the lifting cable 3. The lifting motor is physically connected and or in communication with the control/command system 6 which controls the winding and the unwinding of the lifting cable 3.

The strands of the lifting cable 3 are attached to a distribution trolley 5 mobile in translation horizontally on a track provided along the jib 11, from a rear end-of-travel position X1 located closest to the mast 10 to a front end-of-travel position corresponding to the tip of the jib 11. The track is also constituted by a distribution cable 50 winding and unwinding around the cylinder of a distribution winch 8 coupled to a distribution motor which is controlled by the control/command system 6 to implement the winding or the unwinding. Pulleys are also used for transmitting the movement of the distribution cable 50 so that the distribution trolley 5 moves between the two front and rear X1 end-of-travel positions.

The automatic method may be implemented in the case of self-erecting cranes 1 and top-slewing cranes 1 equipped with a simple reeving (two strands, as illustrated in FIG. 1 as well as in FIG. 2 and FIG. 4) or with a double reeving (four strands).

The determination of the physical end-of-travel position zphys by the automatic method is based on a measurement by a monitoring device 4 of the force F exerted on the strand 30 of the lifting cable 3 when the reeve-block 2 is raised in the direction of the jib 10; the physical end-of-travel position zphys being reached when the reeve-block 2 comes into abutment under/against the distribution trolley 5, the monitoring device 4 then measuring a variation of the force F.

The monitoring device 4 is physically connected and/or in communication with the control/command system 6 in order to transmit the measured forces F to it. Depending on the measured values of force F, the control/command system 6 implements or does not implement the various phases that the automatic method comprises and which are described later. The force F on the strand 30 of the lifting cable 3 is measured by the monitoring device 4 and transmitted to the control/command system 6 in continuous/real time.

In the described embodiment, the monitoring device 4 is a load sensor, more precisely a gauge pin mounted on a return system associated with one of the pulleys used to transmit the winding movement or the unwinding movement of the lifting cable 3; the gauge pin being used to determine the weight of the load suspended from the reeve-block 2 when the crane 1 is working, and measuring a torsional force transmitted to the command control system 6 and from which the automatic method deduces the force F exerted on the strand of the lifting cable 3.

As previously explained, the advantage of this embodiment is to implement the automatic method for determining the end-of-travel position zphys by the control/command system 6 of the crane 1 on the basis of the measurements carried out by a load sensor with which it is basically equipped, so that the automatic method does not require the installation and/or the integration of additional external systems for its execution.

The automatic method is launched by the crane operator when starting the crane 1 at the start of the day, preferably with the reeve-block 2 empty to guarantee the accuracy of measurement of the force F on the strand 30 of the lifting cable 3 by the monitoring device 4, the force F then being due only to the self-weight of the reeve-block 2 which is constant, and in order not to exert, by hanging a load on the hook 20 of the reeve-block 2, unnecessary overtension on the lifting cable 3 at the moment of contact between the reeve-block 2 and the distribution trolley 5 and which could lead in the worst case to a breakage in the cable. Also, the automatic method is started with the distribution trolley 5 in its rear end-of-travel position X1.

In a variant, it is possible for the automatic method to launch automatically when the crane 1 is started without the intervention of the crane operator, so that the operator cannot derogate from the procedure for calibrating the physical end-of-travel of the reeve-block 2. Before launching the automatic method, the control/command system 6 checks whether the distribution trolley 5 is in its rear end-of-travel position X1. If not, it controls the distribution winch 8 to bring the distribution trolley 5 back to the rear end-of-travel position X1 before launch.

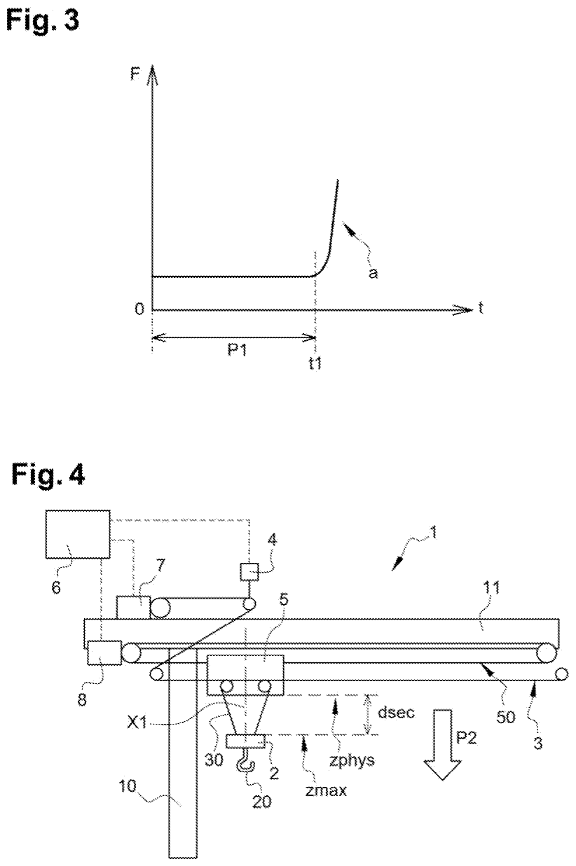

With reference to FIG. 1 and FIG. 3, the automatic method begins with an ascent phase P1, the start of the ascent phase P1 being indicated on the force evolution curve of FIG. 3 at the instant t=0. During the ascent phase P1, the reeve-block 2 is raised in the direction of the jib 11 at a low speed which is lower than a minimum speed vmin, this in order to avoid damaging the reeve-block 2 and/or the distribution trolley 5, or even the elements of the jib 11, when the reeve-block 2 must come into contact with the distribution trolley 5. The minimum speed vmin is a predetermined parameter which depends on the type of crane 1 used, the speed drive installed, the lifting winch 7, and the reeving system.

As indicated previously, given that the raising is carried out with the reeve-block 2 empty, the force F on the strand 30 depends only on the self-weight of the reeve-block 2. This is why the force F, as observable in FIG. 3, is constant during the ascent phase P1.

With reference to FIG. 2 and FIG. 3, when the reeve-block 2 comes into contact with the underside of the distribution trolley 5, corresponding to the instant t=t1 on the evolution curve, the monitoring device 4 detects a sudden increase of the force F on the strand 30. This sudden increase, which corresponds to the overtension exerted in the lifting cable 3 by the reeve-block 2 which, even blocked under the distribution trolley 5, tries to continue to ascent, may be characterized by an exceeding of the force F beyond a given force threshold, or by a slope of variation a of the force above a given slope value as illustrated in this embodiment. Following this detection, the ascent phase P1 is stopped. The reeve-block 2 is then in the physical end-of-travel position zphys, which is stored by the crane 1, more precisely in this embodiment a memory of the control-command system 6.

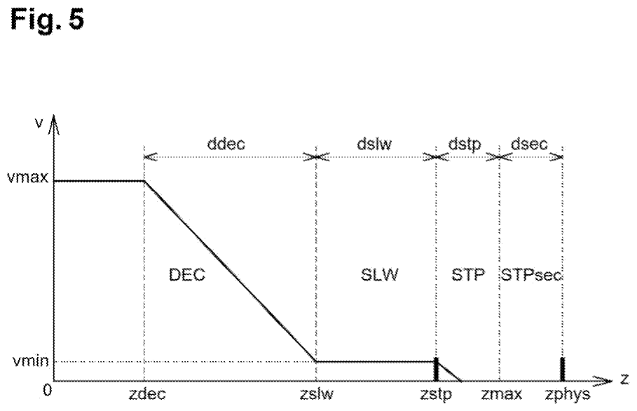

With reference to FIGS. 4 and 5, following the determination of the physical end-of-travel position zphys, the automatic method continues with a calculation step during which it uses the physical end-of-travel position zphys as a reference in order to calculate the maximum end-of-travel position zmax, which corresponds to the height limit that the reeve-block 2 must not exceed when it is raised in the direction of the jib 11 when the crane 1 is working. The maximum end-of-travel position of the reeve-block zmax is determined from a safety distance dsec separating it from the physical end-of-travel position zphys. The value of the safety distance dsec is a predefined parameter which depends on the type of crane 1 considered. It is comprised between 80 and 100 cm for the top-slewing cranes, and between 40 and 80 cm for the self-erecting cranes. Advantageously, as explained previously, the safety distance dsec, thanks to the automatic method, may eventually be reduced. The maximum end-of-travel position zmax is also stored in this embodiment by the control/command system 6.

Following the calculation step, the automatic method implements a descent phase P2 during which the reeve-block 2 descended, at a descent speed less than or equal to the minimum speed vmin, in the direction of the ground from the physical end-of-travel position zphys to the maximum end-of-travel position zmax.

In a first variant of the present subject matter, the automatic method ends at the end of the descent phase P2.

In other variants, the automatic method may also calculate, by continuing to use the physical end-of-travel position zphys as a reference, other positions serving to establish different speed regulation areas of the reeve-block 2 when raised in the direction of the jib 11 and when the crane 11 is working.

Thus, with reference to FIG. 5, the automatic method may calculate:
a stop position zstp located below the maximum end-of-travel position zmax at a stop distance dstp, and/or
a slow-down position zslw which is located below the stop position zstp at a slow-down distance dslw, and/or
a deceleration position zdec which is located below the slow-down position zslw at a deceleration distance ddec.

Given that these three positions are relatively far from the maximum end-of-travel position zmax, the reeve-block 2 may be descended to reach them, during the implementation of the automatic method, at a descent speed greater than the minimum speed vmin.

All of these positions may also be stored, for example, by a memory of the control/command system 6 of the crane 1, in order to be used during periods of activity (or work) of the crane, so as to control the ascents of the reeve-block 2 in a secure manner.

The deceleration distance ddec corresponds to a deceleration area DEC.

The slow-down distance dslw corresponds to a slow-down area SLW.

The stop distance dstp corresponds to a stop area STP.

The ascent speed v of the reeve-block 2 towards the jib 11 is thus regulated, more precisely gradually reduced, by the lifting limiter of the crane 1 as the reeve-block 2 successively enters the deceleration area DEC, the slow-down area SLW, and finally the stop area STP. When the reeve-block 2 is located below the deceleration position, it may be raised at the maximum speed vmax.

The safety distance dsec comprised between the maximum end-of-travel position zmax and the physical end-of-travel position zphys corresponds to a safe stop area STPsec. As indicated previously, when the crane 1 is working, this safe stopping area STPsec is a prohibited area in which the reeve-block 2 must not enter.

It should be noted that the reeve-block 2 may be descended in the direction of the ground at the maximum speed vmax regardless of the area in which it is located, with the exception therefore of the safe stop area STPsec, once the stop position zstp, the slow-down position zslw, and the deceleration position zdec have been determined.

1-15. (canceled)

16. An automatic method for determining a physical end-of-travel position (zphys) of a reeve-block of a crane configured to be moved in ascent and in descent by a lifting cable, the reeve-block being suspended by the lifting cable from a distribution trolley, the automatic method comprising:
during an ascent phase (P1) of the reeve-block, measuring by a monitoring device, a force (F) on a strand of the lifting cable, and,
determining the physical end-of-travel position (zphys) being reached depending on a variation of the force (F) on the strand of the lifting cable, wherein the physical end-of-travel position corresponds to a position at which the reeve-block is physically in contact with the distribution trolley.

17. The automatic method according to claim 16, wherein the physical end-of-travel position (zphys) is determined from an increase of the force (F) on the strand of the lifting cable.

18. The automatic method according to claim 17, wherein the increase of the force (F) on the strand of the lifting cable is characterized by an exceeding of the force (F) beyond a given force threshold, or by a slope of variation (a) of the force (F) above a given slope value.

19. The automatic method according to claim 16, wherein the ascent phase (P1) is carried out with the reeve-block empty.

20. The automatic method according to claim 16, wherein the ascent phase (P1) is carried out at an ascent speed (v) below a minimum speed (vmin).

21. The automatic method according to claim 16, wherein the ascent phase (P1) is stopped as soon as the physical end-of-travel position (zphys) is reached and determined.

22. The automatic method according to claim 16, wherein the monitoring device is a load sensor mounted on the crane and configured to measure a self-weight of the reeve-block.

23. The automatic method according to claim 22, wherein the load sensor is a gauge pin mounted on a system for retuning the lifting cable.

24. The automatic method according to claim 16, further comprising a step of calculating a maximum end-of-travel position (zmax) of the reeve-block, located below the physical end-of-travel position at a predefined safety distance (dsec).

25. The automatic method according to claim 24, wherein the safety distance (dsec) is comprised between 40 and 100 cm.

26. The automatic method according to claim 24, wherein, once the physical end-of-travel position (zphys) has been reached and determined, the reeve-block is descended until reaching the maximum end-of-travel position (zmax).

27. The automatic method according to claim 24, wherein the maximum end-of-travel position (zmax) is a maximum position not to be exceeded by the reeve-block when the crane is working.

28. The automatic method according to claim 16, wherein the automatic method is carried out when starting the crane, before any work of moving a load.

29. The automatic method according to claim 16, wherein the automatic method is repeated between two periods of activity of the crane.

30. The automatic method according to claim 16, wherein the automatic method is implemented in a control/command system included in the crane, the control/command system being linked at least to a lifting winch coupled to the lifting cable, and to the monitoring device.
